(19) United States
(12) Patent Application Publication
(10) Pub. No.: US 2017/0132457 A1
(43) Pub. Date: May 11, 2017

(54) HUMAN FACE SIMILARITY RECOGNITION METHOD AND SYSTEM

(71) Applicant: BEIJING QIHOO TECHNOLOGY COMPANY LIMITED, Beijing (CN)

(72) Inventors: Maoqing ZHU, Beijing (CN); Yu TANG, Beijing (CN); Hongxia XUE, Beijing (CN); Jinhui HU, Beijing (CN); Zhang LI, Beijing (CN); Yugang Han, Beijing (CN)

(73) Assignee: BEIJING QIHOO TECHNOLOGY COMPANY LIMITED, Beijing (CN)

(21) Appl. No.: 15/322,350

(22) PCT Filed: Jun. 26, 2015
(86) PCT No.: PCT/CN2015/082550

§ 371 Date: Dec. 27, 2016

(30) Foreign Application Priority Data
Jun. 27, 2014 (CN) 201410302816.X
Jun. 30, 2014 (CN) 201410306005.7

(51) Int. Cl. G06K 9/00; G06K 9/62

(52) U.S. Cl. CPC G06K 9/00281; G06K 9/6215; G06K 9/6218

(57) ABSTRACT

The invention provides a human face similarity recognition method and system, which relate to the field of computer technologies and are used for recognizing similar human face pictures accurately. The human face similarity recognition method comprises: generating a feature vector of a target human face picture according to features of the target human face picture; generating feature vectors of collected human face pictures according to features of the collected human face pictures; and selecting from the collected human face pictures at least one human face picture of which the feature vector has the minimum distance to the feature vector of the target human face picture as a similar human face picture of the target human face picture. The invention is beneficial to recognition of different pictures of the same human face which have a difference in expression, makeup or face angle, etc.

### FIELD OF THE INVENTION

The invention relates to the field of computer technologies, and in particular, to a human face similarity recognition method and system.

### BACKGROUND OF THE INVENTION

Computation of human face similarity in the prior art is to obtain histograms of single channel images by clipping different human face pictures and transforming them into the single channel images, and compute the similarity between different human faces by comparing the difference between the histograms of the different human face pictures.

The defect of the above scheme lies in that, after changes in facial expression, make-up, face angle, etc. have taken place on one and the same human face, it will result in that a very large difference will occur to histograms of different pictures of the same human face, and computation of human face similarity based on the histograms may get a result of a relatively low similarity between the different pictures of the same human face, which shows that the computational result is quite inaccurate.

### SUMMARY OF THE INVENTION

In view of the above problems, the invention is proposed to provide a human face similarity recognition method and system, which overcome the above problems or at least in part solve the above problems.

According to an aspect of embodiments of the invention, there is provided a human face similarity recognition method comprising: generating a feature vector of a target human face picture according to features of the target human face picture; generating feature vectors of collected human face pictures according to features of the collected human face pictures; and selecting from the collected human face pictures at least one human face picture of which the feature vector has the minimum distance to the feature vector of the target human face picture as a similar human face picture of the target human face picture.

Optionally, the step of selecting from the collected human face pictures at least one human face picture of which the feature vector has the minimum distance to the feature vector of the target human face picture as a similar human face picture of the target human face picture comprises:

aggregating the collected human face pictures into a plurality of categories;

computing a vector center point of human face pictures in each category according to the feature vectors of the human face pictures in said each category; and

taking a human face picture in a category corresponding to a vector center point with the minimum distance to the feature vector of the target human face picture as a similar human face picture of the target human face picture.

Optionally, the method further comprises:

converting the distance between the feature vector of the similar human face picture and the feature vector of the target human face picture into a similarity score between the similar human face picture and the target human face picture.

Optionally, the step of converting the distance between the feature vector of the similar human face picture and the feature vector of the target human face picture into a similarity score between the similar human face picture and the target human face picture comprises:

when Dx<=Dmin, taking S=Smax, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score; and/or

when Di<Dx<=D(i+1), taking S=Si+K(Dx−Di), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture; and/or

when Dx>Dmax, taking S=Smin, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

Optionally, the method further comprises:

when there are a plurality of the similar human face pictures, sorting the plurality of the similar human face pictures according to the similarities between the similar human face pictures and the target human face picture.

Optionally, the step of selecting from the collected human face pictures at least one human face picture of which the feature vector has the minimum distance to the feature vector of the target human face picture as a similar human face picture of the target human face picture comprises:

clustering the collected human face pictures to obtain a plurality of 1st level categories, and through an iterative approach, continuing to cluster human face pictures in at least one i-th level category to obtain a plurality of (i+1)-th level categories, wherein i takes an integer value backward from 1 in order;

recognizing a 1st level category that the target human face picture belongs to, and through an iterative approach, continuing to recognize a (j+1)-th level category that the target human face picture belongs to in a j-th level category that the target human face picture belongs to, wherein j takes an integer value backward from 1 in order; and

continuing to recognize a (j+1)-th level category by the iterative approach, until there is no (j+1)-th level category in the j-th level category that the target human face picture belongs to, and recognizing a similar human face picture of the target human face picture from the j-th level category that the target human face picture belongs to.

Optionally, the step of clustering the collected human face pictures to obtain a plurality of 1st level categories comprises:

setting a plurality of initial center points, dividing the collected human face pictures into a plurality of 1st level categories according to the distances between the feature vectors of the collected human face pictures and each of the initial center points, and computing a vector center point of each 1st level category according to the feature vectors of the human face pictures of said each 1st level category.

Optionally, the step of clustering the collected human face pictures to obtain a plurality of 1st level categories further comprises:

computing the variance between the initial center point and the vector center point of said each 1st level category; and

if the variance exceeds a preset threshold, re-setting the initial center points, re-dividing the collected human face pictures into a plurality of 1st level categories, and re-computing a vector center point of each 1st level category.

Optionally, the step of recognizing a 1st level category that the target human face picture belongs to comprises:

selecting a 1st level category of which the vector center point has the minimum distance to the feature vector of the target human face picture as the 1st level category that the target human face picture belongs to.

Optionally, the step of recognizing a similar human face picture of the target human face picture comprises:

selecting from the human face pictures of the j-th level category at least one human face picture of which the feature vector has the minimum distance to the feature vector of the target human face picture as the similar human face picture of the target human face picture.

According to another aspect of embodiments of the invention, there is further provided a human face similarity recognition system comprising: a first feature vector generation module configured for generating a feature vector of a target human face picture according to features of the target human face picture; a second feature vector generation module configured for generating feature vectors of collected human face pictures according to features of the collected human face pictures; and a first similar human face picture recognition module configured for selecting from the collected human face pictures at least one human face picture of which the feature vector has the minimum distance to the feature vector of the target human face picture as a similar human face picture of the target human face picture.

Optionally, the system further comprises:

a first categorization module configured for aggregating the collected human face pictures into a plurality of categories;

a vector center point computation module configured for computing a vector center point of human face pictures in each category according to the feature vectors of the human face pictures in said each category; and

the first similar human face picture recognition module is configured for taking a human face picture in a category corresponding to a vector center point with the minimum distance to the feature vector of the target human face picture as a similar human face picture of the target human face picture.

Optionally, the system further comprises:

a similarity score computation module configured for converting the distance between the feature vector of the similar human face picture and the feature vector of the target human face picture into a similarity score between the similar human face picture and the target human face picture.

Optionally, the similarity score computation module takes S=Smax when Dx<=Dmin, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score; and/or

the similarity score computation module takes S=Si+K(Dx−Di) when Di<Dx<=D(i+1), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture; and/or

the similarity score computation module takes S=Smin when Dx>Dmax, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

Optionally, the system further comprises:

a sorting module configured for, when there are a plurality of the similar human face pictures, sorting the plurality of the similar human face pictures according to the similarities between them and the target human face picture.

Optionally, the system further comprises:

a second categorization module configured for clustering the collected human face pictures to obtain a plurality of 1st level categories, and through an iterative approach, continuing to cluster human face pictures in at least one i-th level category to obtain a plurality of (i+1)-th level categories, wherein i takes an integer value backward from 1 in order;

an iterative category recognition module configured for recognizing a 1st level category that the target human face picture belongs to, and through an iterative approach, continuing to recognize a (j+1)-th level category that the target human face picture belongs to in a j-th level category that the target human face picture belongs to, wherein j takes an integer value backward from 1 in order; and

a second similar human face picture recognition module configured for, when there is no (j+1)-th level category in the j-th level category that the target human face picture belongs to, recognizing a similar human face picture of the target human face picture from the j-th level category that the target human face picture belongs to.

Optionally, the second categorization module sets a plurality of initial center points, divides the collected human face pictures into a plurality of 1st level categories according to the distances between the feature vectors of the collected human face pictures and each of the initial center points, and computes a vector center point of each 1st level category according to the feature vectors of the human face pictures of said each 1st level category.

Optionally, the system further comprises:

a variance computation module which computes the variance between the initial center point and the vector center point of said each 1st level category; and

if the variance exceeds a preset threshold, the categorization module re-sets the initial center points, re-divides the collected human face pictures into a plurality of 1st level categories, and re-computes a vector center point of each 1st level category.

Optionally, the second categorization module selects a 1st level category of which the vector center point has the minimum distance to the feature vector of the target human face picture as the 1st level category that the target human face picture belongs to.

Optionally, the second similar human face picture recognition module selects from the human face pictures of the j-th level category at least one human face picture of which the feature vector has the minimum distance to the feature vector of the target human face picture as the similar human face picture of the target human face picture.

According to still another aspect of the invention, there is provided a computer program comprising a computer readable code which causes a computing device to perform a method described in the invention, when said computer readable code is running on the computing device.

According to yet still another aspect of the invention, there is provided a computer readable medium storing therein the computer program described in the invention.

The beneficial effects of the invention are as follows:

in embodiments of the invention, features of different human face pictures are processed to be feature vectors, vector distances between the feature vectors are computed, and a similar human face picture is recognized according to the sizes of vector distances; when changes in facial expression, make-up, face angle, etc. have taken place on different pictures of one and the same human face, features of the human face on the different pictures may keep unchanged or change little, and then the distances between the feature vectors of the different pictures are also necessarily small, that is, the similarities between the different human face pictures are large, which facilitates recognizing different pictures of one and the same human face that have differences in facial expression, make-up, face angle, etc.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a flow chart of a human face similarity recognition method according to an embodiment of the invention;

FIG. 2 shows a flow chart of a human face similarity recognition method according to an embodiment of the invention;

FIG. 3 shows a flow chart of a human face similarity recognition method according to an embodiment of the invention;

FIG. 4 shows a schematic diagram of the work of a human face recognition method according to an embodiment of the invention;

FIG. 5 shows a flow chart of a human face similarity recognition method according to an embodiment of the invention;

FIG. 6 shows a flow chart of a human face similarity recognition method according to an embodiment of the invention;

FIG. 7 shows a flow chart of a human face similarity recognition method according to an embodiment of the invention;

FIG. 8 shows a block diagram of a human face similarity recognition system according to an embodiment of the invention;

FIG. 9 shows a block diagram of a human face similarity recognition system according to an embodiment of the invention;

FIG. 10 shows a block diagram of a human face similarity recognition system according to an embodiment of the invention;

FIG. 11 shows a block diagram of a human face similarity recognition system according to an embodiment of the invention;

FIG. 12 shows a block diagram of a human face similarity recognition system according to an embodiment of the invention;

FIG. 13 shows a block diagram of a human face similarity recognition system according to an embodiment of the invention;

FIG. 14 shows a block diagram of a human face similarity recognition system according to an embodiment of the invention;

FIG. 15 shows schematically a block diagram of a computing device for performing a method according to the invention; and

FIG. 16 shows schematically a storage unit for retaining or carrying a program code implementing a method according to the invention.

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

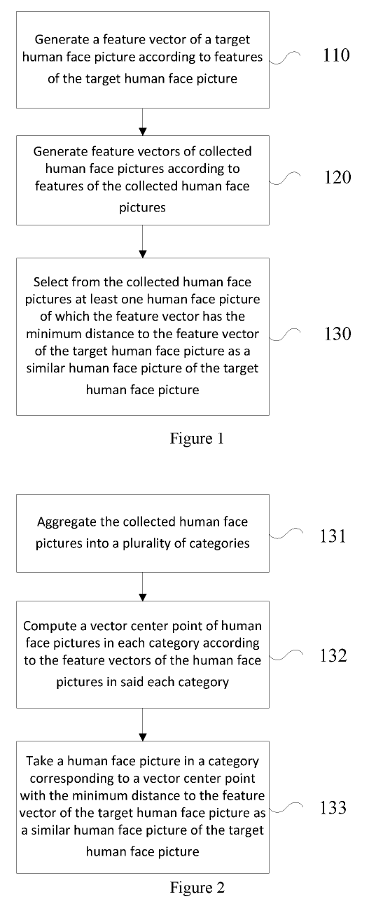

An embodiment of the invention provides a human face similarity recognition method. FIG. 1 shows a processing flow chart of a human face similarity recognition method according to an embodiment of the invention. With reference to FIG. 1, the human face similarity recognition method comprises at least step 110 to step 130.

At the step 110, a feature vector of a target human face picture is generated according to features of the target human face picture. The features of the target human face picture may be extracted in real time. According to the number of the extracted features, the feature vector may be a multi-dimensional vector, for example, a 400-dimensional vector. The features of the embodiment comprise, but are not limited to, the shape and location, etc. of a facial organ.

At the step 120, feature vectors of collected human face pictures are generated according to features of the collected human face pictures. The features of the collected human face pictures may be extracted and stored in advance. According to the number of the extracted features, the feature vectors may be multi-dimensional vectors, for example, 400-dimensional vectors. The features of the embodiment comprise, but are not limited to, the shape and location, etc. of a facial organ.

At the step 130, from the collected human face pictures, at least one human face picture of which the feature vector has the minimum distance to the feature vector of the target human face picture is selected as a similar human face picture of the target human face picture. In the technical solution of the embodiment, if the target human face picture and a certain collected human face picture are different pictures of one and the same human face, the features of the two are necessarily identical or the difference thereof is relatively small, and the distance between the feature vectors of the two is also necessarily small, and therefore the technical solution of the embodiment facilitates recognizing different pictures of one and the same human face.

As shown in FIG. 2, another embodiment of the invention proposes a human face similarity recognition method. As compared to the above embodiment, in the human face similarity recognition method of this embodiment, the step 130 comprises the following steps.

At step 131, the collected human face pictures are aggregated into a plurality of categories. For example, the collected human face pictures are divided into three categories, C1, C2 and C3. There are many existing clustering approaches, which may all be adopted in the technical solution of this embodiment.

At step 132, a vector center point of human face pictures in each category is computed according to the feature vectors of the human face pictures in said each category. For example, the vector center points of the three categories are taken as R1, R2 and R3, respectively.

At step 133, a human face picture in a category corresponding to a vector center point with the minimum distance to the feature vector of the target human face picture is taken as a similar human face picture of the target human face picture. For example, suppose that the values of the vector distances between the target human face picture Q and R1, R2 and R3 are 1.4, 1.25 and 0.2, respectively, wherein the distance between Q and R3 is minimal, and then a human face picture in the category C3 corresponding to R3 is taken as a similar human face picture.

In the technical solution of this embodiment, vector center points of a plurality of categories are obtained by clustering, and the vector center points are compared with the feature vector of the target human face picture, which avoids that the feature vectors of all the collected human face pictures are compared with the feature vector of the target human face picture one by one, reduces the amount of computation, and improves the efficiency of picture recognition.

A further embodiment of the invention proposes a human face similarity recognition method. As compared to the above embodiments, the human face similarity recognition method of this embodiment further comprises:

converting the distance between the feature vector of the similar human face picture and the feature vector of the target human face picture into a similarity score between the similar human face picture and the target human face picture. For example, in combination with the above embodiments, suppose that the minimum vector distances between human face pictures in the category C3 and the target human face picture are successively 0.01, 0.2, 1.2, and the three distance values are converted into similarity scores 100, 91, 85 according to a predetermined formula, and then the similarity score may reflect the similarity between the target human face picture and a similar human face picture.

A further embodiment of the invention proposes a human face similarity recognition method. As compared to the above embodiments, in the human face similarity recognition method of this embodiment, the step of converting the distance between the feature vector of the similar human face picture and the feature vector of the target human face picture into a similarity score between the similar human face picture and the target human face picture comprises:

when Dx<=Dmin, taking S=Smax, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score;

when Di<Dx<=D(i+1), taking S=Si+K(Dx−Di), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture;

when Dx>Dmax, taking S=Smin, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

In the technical solution of this embodiment, a technical solution of converting a vector distance into a similarity score is proposed, and the similarity score is reduced with the decrease of the vector distance, and it can reasonably reflect the degree of similarity between the target human face picture and the similar human face picture.

A further embodiment of the invention proposes a human face similarity recognition method. As compared to the above embodiments, the human face similarity recognition method of this embodiment further comprises:

when there are a plurality of the similar human face pictures, sorting the plurality of the similar human face pictures according to the similarities between them and the target human face picture.

In the technical solution of this embodiment, since a human face picture with the highest similarity is generally a picture required by a user, sorting the plurality of the similar human face pictures facilitates quickly providing the user with a picture that he requires.

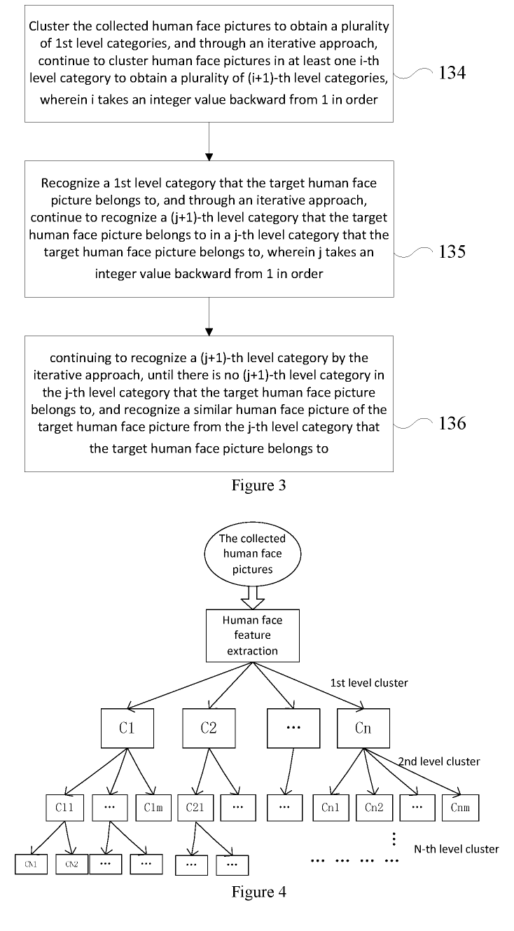

As shown in FIG. 3, a further embodiment of the invention proposes a human face similarity recognition method. As compared to the above embodiments, in the human face similarity recognition method of this embodiment, the step 130 comprises the following steps.

At step 134, it clusters the collected human face pictures to obtain a plurality of 1st level categories, and through an iterative approach, continues to cluster human face pictures in at least one i-th level category to obtain a plurality of (i+1)-th level categories, wherein i takes an integer value backward from 1 in order. In this embodiment, a formed multi-level category structure is as shown in FIG. 4, for example, wherein the category C1 comprises a plurality of categories such as C11, . . . , C1m, etc., and the category C11 in turn comprises categories such as CN1, CN2, etc.

At step 135, it recognizes a 1st level category that the target human face picture belongs to, and through an iterative approach, continues to recognize a (j+1)-th level category that the target human face picture belongs to in a j-th level category that the target human face picture belongs to, wherein j takes an integer value backward from 1 in order.

At step 136, it continues to recognize a (j+1)-th level category by the iterative approach, until there is no (j+1)-th level category in the j-th level category that the target human face picture belongs to, and recognizes a similar human face picture of the target human face picture from the j-th level category that the target human face picture belongs to.

In the technical solution of this embodiment, the collected human face pictures are clustered into a multi-level structure by dividing and clustering again a clustered result of an upper level by an iterative approach, and a category that the target human face picture belongs to is sought level by level by an iterative approach, until a similar human face picture of the target human face picture is found finally. As compared to the existing technical solution, the amount of computation of the technical solution of the invention is very small, which greatly improves the efficiency of human face recognition.

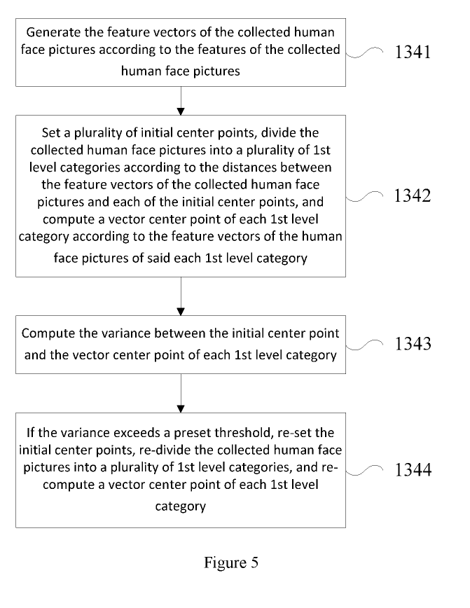

As shown in FIG. 5, a further embodiment of the invention provides a human face similarity recognition method, wherein the step 134 comprises the following steps.

At step 1341, the feature vectors of the collected human face pictures are generated according to the features of the collected human face pictures. This embodiment is based on the extraction of the features of the collected human face pictures, and the features of the collected human face pictures may be extracted and stored in a feature library in advance.

At step 1342, a plurality of initial center points are set, the collected human face pictures are divided into a plurality of 1st level categories according to the distances between the feature vectors of the collected human face pictures and each of the initial center points, and a vector center point of each 1st level category is computed according to the feature vectors of the human face pictures of said each 1st level category.

According to the technical solution of this embodiment, the collected human face pictures are allocated to nearest categories according to the distances between the feature vectors of the collected human face pictures and the initial center points, and afterwards, vector center points are computed; and so again and again, a multi-level clustering structure may be formed quickly.

A further embodiment of the invention provides a human face similarity recognition method, wherein the step 134 further comprises the following steps.

At 1343, the variance between the initial center point and the vector center point of each 1st level category is computed. This embodiment is based on the extraction of the feature of the target human face picture, and the feature of the target human face picture may be extracted in real time.

At 1344, if the size of the variance exceeds a preset threshold, the initial center points are re-set, the collected human face pictures are re-divided into a plurality of 1st level categories, and a vector center point of each 1st level category is re-computed.

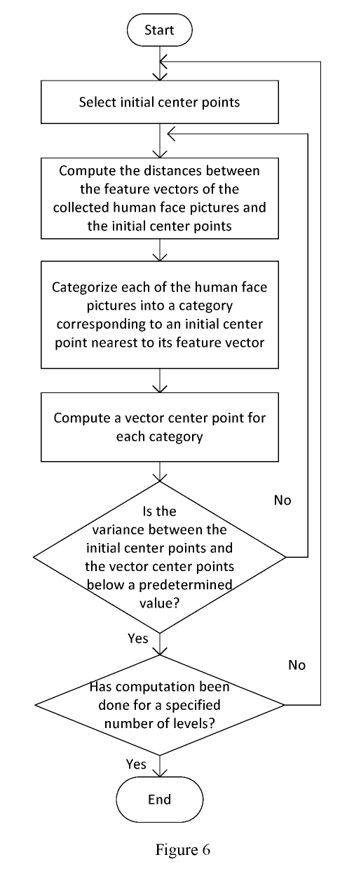

In the technical solution of this embodiment, if the variance <0.000001 (as an example, which may take other value), it indicates that what are in the category are human face pictures with close features, otherwise, it indicates that the category has human face pictures with clearly different features and unsuitable for being placed in one and the same category, and therefore re-categorization needs to be conducted. At this point, a work flow of the human face recognition method of this embodiment may be as shown in FIG. 6, wherein the step at which computation has been done for a specified number of levels refers to clustering the collected human face pictures into a clustering structure of a specified number of levels.

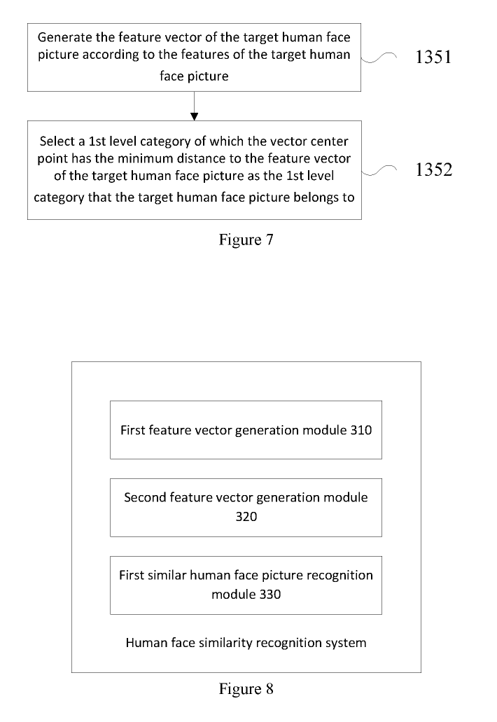

As shown in FIG. 7, a further embodiment of the invention provides a human face similarity recognition method, wherein the step 135 comprises:

step 1351, generating the feature vector of the target human face picture according to the features of the target human face picture; and

step 1352, selecting a 1st level category of which the vector center point has the minimum distance to the feature vector of the target human face picture as the 1st level category that the target human face picture belongs to.

According to the technical solution of this embodiment, in the structure of an individual level, the feature vector of the target human face picture is compared with vector center points of multiple lower level categories in an upper level category that it belongs to, which may quickly find the smallest category that the target human face picture belongs to.

A further embodiment of the invention provides a human face similarity recognition method, wherein the step 136 comprises:

selecting from the human face pictures of the j-th level category at least one human face picture of which the feature vector has the minimum distance to the feature vector of the target human face picture as the similar human face picture of the target human face picture.

According to the above embodiments, suppose that there are 10 million collected human face pictures, when it is necessary to retrieve a similar human face picture of the target human face picture,

1. if a direct comparison approach is used, the feature vector of the target human face picture needs to be compared with a feature vector of a collected human face picture for 10 million times;

2. if a conventional clustering approach is used to divide the 10 million data into 10 thousand clusters, the target human face picture needs to be compared with a vector center point of a cluster for 10 thousand times; each cluster has 1,000 pieces of data on average, and the comparison needs to be done 1,000 times inside each category; the comparison is done 10000+k×1000 times in total; for example, k takes 10, and then the number of times of comparison is 10000+10*1000=20000; wherein when a similar human face picture of the target human face picture is sought in the clusters by an existing near neighbor algorithm, k means that k near neighbor center points are selected, and 10 is its common value;

3. if the technical solution of this embodiment is used, two levels are divided, and there are 100 clusters at the first level, and there are 200 clusters at the second level, then each cluster at the second level has 500 pieces of data on average, and the number of times of comparison is about 100+m×200+n×500;

if m=3, and n=10, the number of times of comparison is 100+3×200+10×500=11100, which may reduce the number of times that the comparison is done significantly as compared to the 1st and the 2nd sections; likewise, m means that m near neighbor center points are selected at the first level, n means that n near neighbor center points are selected at the second level, and 3, 10 are common values.

As shown in FIG. 8, a further embodiment of the invention provides a human face similarity recognition system comprising the following modules.

A first feature vector generation module 310 is configured for generating a feature vector of a target human face picture according to features of the target human face picture. The features of the target human face picture may be extracted in real time. According to the number of the extracted features, the feature vector may be a multi-dimensional vector, for example, a 400-dimensional vector. The features of the embodiment comprise, but are not limited to, the shape and location, etc. of a facial organ.

A second feature vector generation module 320 is configured for generating feature vectors of collected human face pictures according to features of the collected human face pictures. The features of the collected human face pictures may be extracted and stored in advance. According to the number of the extracted features, the feature vectors may be multi-dimensional vectors, for example, 400-dimensional vectors. The features of the embodiment comprise, but are not limited to, the shape and location, etc. of a facial organ.

A first similar human face picture recognition module 330 is configured for selecting from the collected human face pictures at least one human face picture of which the feature vector has the minimum distance to the feature vector of the target human face picture as a similar human face picture of the target human face picture. In the technical solution of this embodiment, if the target human face picture and a certain collected human face picture are different pictures of one and the same human face, the features of the two are necessarily identical or the difference thereof is relatively small, and the distance between the feature vectors of the two is also necessarily small, and therefore the technical solution of this embodiment facilitates recognizing different pictures of one and the same human face.

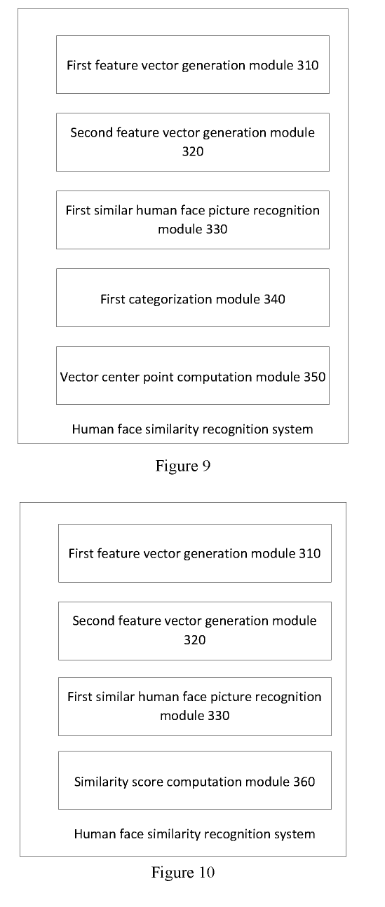

As shown in FIG. 9, a further embodiment of the invention proposes a human face similarity recognition system. As compared to the above embodiment, the human face similarity recognition system of this embodiment further comprises the following modules.

A first categorization module 340 is configured for aggregating the collected human face pictures into a plurality of categories. For example, the collected human face pictures are divided into three categories, C1, C2 and C3. There are many existing clustering approaches, which may all be adopted in the technical solution of this embodiment.

A vector center point computation module 350 is configured for computing a vector center point of human face pictures in each category according to the feature vectors of the human face pictures in said each category. For example, the vector center points of the three categories are taken as R1, R2 and R3, respectively.

The first similar human face picture recognition module 330 is configured for taking a human face picture in a category corresponding to a vector center point with the minimum distance to the feature vector of the target human face picture as a similar human face picture of the target human face picture. For example, suppose that the values of the vector distances between the target human face picture Q and R1, R2 and R3 are 1.4, 1.25 and 0.2, respectively, wherein the distance between Q and R3 is minimal, and then a human face picture in the category C3 corresponding to R3 is taken as a similar human face picture.

In the technical solution of this embodiment, vector center points of a plurality of categories are obtained by clustering, and the vector center points are compared with the feature vector of the target human face picture, which avoids that the feature vectors of all the collected human face pictures are compared with the feature vector of the target human face picture one by one, reduces the amount of computation, and improves the efficiency of picture recognition.

As shown in FIG. 10, a further embodiment of the invention proposes a human face similarity recognition system. As compared to the above embodiments, the human face similarity recognition system of this embodiment further comprises:

a similarity score computation module 360 configured for converting the distance between the feature vector of the similar human face picture and the feature vector of the target human face picture into a similarity score between the similar human face picture and the target human face picture. For example, in combination with the above embodiments, suppose that the minimum vector distances between human face pictures in the category C3 and the target human face picture are successively 0.01, 0.2, 1.2, and the three distance values are converted into similarity scores 100, 91, 85 according to a predetermined formula, and then the similarity score may reflect the similarity between the target human face picture and a similar human face picture.

A further embodiment of the invention proposes a human face similarity recognition system. As compared to the above embodiments, in the human face similarity recognition system of this embodiment, the similarity score computation module 360 takes S=Smax when Dx<=Dmin, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score;

the similarity score computation module 360 takes S=Si+K(Dx−Di) when Di<Dx<=D(i+1), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture;

the similarity score computation module 360 takes S=Smin when Dx>Dmax, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

In the technical solution of this embodiment, a technical solution of converting a vector distance into a similarity score is proposed, and the similarity score is reduced with the decrease of the vector distance, and it can reasonably reflect the degree of similarity between the target human face picture and the similar human face picture.

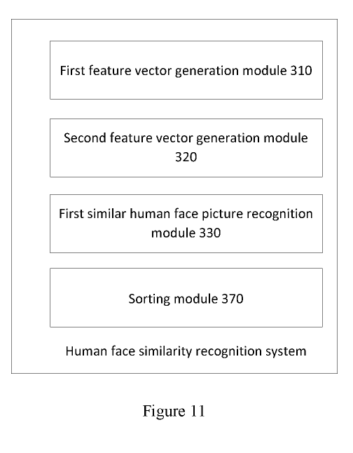

As shown in FIG. 11, a further embodiment of the invention proposes a human face similarity recognition system. As compared to the above embodiments, the human face similarity recognition system of this embodiment further comprises:

a sorting module 370 configured for, when there are a plurality of the similar human face pictures, sorting the plurality of the similar human face pictures according to the similarities between them and the target human face picture.

In the technical solution of this embodiment, since a human face picture with the highest similarity is generally a picture required by a user, sorting the plurality of the similar human face pictures facilitates quickly providing the user with a picture that he requires.

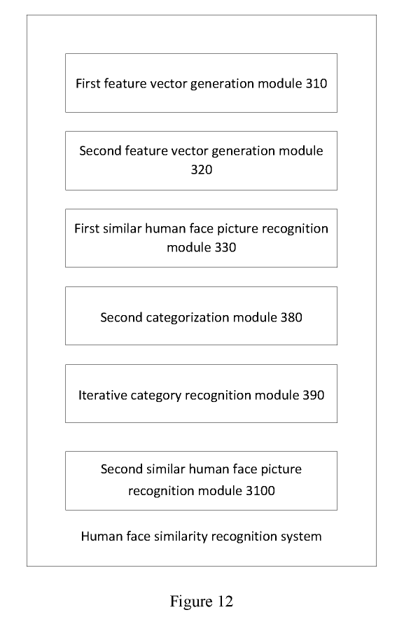

As shown in FIG. 12, a further embodiment of the invention proposes a human face similarity recognition system. As compared to the above embodiments, the human face similarity recognition system of this embodiment further comprises the following modules.

A second categorization module 380 is configured for clustering the collected human face pictures to obtain a plurality of 1st level categories, and through an iterative approach, continuing to cluster human face pictures in at least one i-th level category to obtain a plurality of (i+1)-th level categories, wherein i takes an integer value backward from 1 in order. In this embodiment, a formed multi-level category structure is as shown in FIG. 2, for example, wherein the category C1 comprises a plurality of categories such as C11, . . . , C1m, etc., and the category C11 in turn comprises categories such as CN1, CN2, etc.

An iterative category recognition module 390 is configured for recognizing a 1st level category that the target human face picture belongs to, and through an iterative approach, continuing to recognize a (j+1)-th level category that the target human face picture belongs to in a j-th level category that the target human face picture belongs to, wherein j takes an integer value backward from 1 in order.

A second similar human face picture recognition module 3100 is configured for, when there is no (j+1)-th level category in the j-th level category that the target human face picture belongs to, recognizing a similar human face picture of the target human face picture from the j-th level category that the target human face picture belongs to.

In the technical solution of this embodiment, the collected human face pictures are clustered into a multi-level structure by dividing and clustering again a clustered result of an upper level by an iterative approach, and a category that the target human face picture belongs to is sought level by level by an iterative approach, until a similar human face picture of the target human face picture is found finally. As compared to the existing technical solution, the amount of computation of the technical solution of the invention is very small, which greatly improves the efficiency of human face recognition.

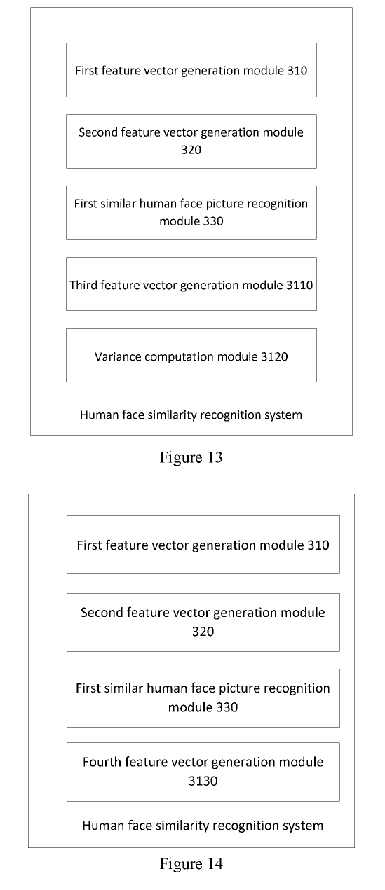

As shown in FIG. 13, a further embodiment of the invention proposes a human face similarity recognition system, which further comprises:

a third feature vector generation module 3110 configured for generating the feature vectors of the collected human face pictures according to the features of the collected human face pictures. This embodiment is based on the extraction of the features of the collected human face pictures, and the features of the collected human face pictures may be extracted and stored in a feature library in advance.

The second categorization module 380 sets a plurality of initial center points, divides the collected human face pictures into a plurality of 1st level categories according to the distances between the feature vectors of the collected human face pictures and each of the initial center points, and computes a vector center point of each 1st level category according to the feature vectors of the human face pictures of said each 1st level category.

According to the technical solution of this embodiment, the collected human face pictures are allocated to nearest categories according to the distances between the feature vectors of the collected human face pictures and the initial center points, and afterwards, vector center points are computed; and so again and again, a multi-level clustering structure may be formed quickly.

A further embodiment of the invention proposes a human face similarity recognition system, which further comprises:

a variance computation module 3120 which computes the variance between the initial center point and the vector center point of each 1st level category. This embodiment is based on the extraction of the feature of the target human face picture, and the feature of the target human face picture may be extracted in real time.

If the size of the variance exceeds a preset threshold, the second categorization module 380 re-sets the initial center points, re-divides the collected human face pictures into a plurality of 1st level categories, and re-computes a vector center point of each 1st level category.

In the technical solution of this embodiment, if the variance <0.000001 (as an example, which may take other value), it indicates that what are in the category are human face pictures with close features, otherwise, it indicates that the category has human face pictures with clearly different features and unsuitable for being placed in one and the same category, and therefore re-categorization needs to be conducted. At this point, a work flow of the human face recognition method of this embodiment may be as shown in FIG. 6, wherein the step at which computation has been done for a specified number of levels refers to clustering the collected human face pictures into a clustering structure of a specified number of levels.

As shown in FIG. 14, a further embodiment of the invention proposes a human face similarity recognition system, which further comprises:

a fourth feature vector generation module 3130 configured for generating the feature vector of the target human face picture according to the features of the target human face picture.

The second categorization module 380 selects a 1st level category of which the vector center point has the minimum distance to the feature vector of the target human face picture as the 1st level category that the target human face picture belongs to.

According to the technical solution of this embodiment, in the structure of an individual level, the feature vector of the target human face picture is compared with vector center points of multiple lower level categories in an upper level category that it belongs to, which may quickly find the smallest category that the target human face picture belongs to.

A further embodiment of the invention provides a human face similarity recognition system, wherein the second similar human face picture recognition module 3100 selects from the human face pictures of the j-th level category at least one human face picture of which the feature vector has the minimum distance to the feature vector of the target human face picture as the similar human face picture of the target human face picture.

According to the above embodiments, suppose that there are 10 million collected human face pictures, when it is necessary to retrieve a similar human face picture of the target human face picture,

1. if a direct comparison approach is used, the feature vector of the target human face picture needs to be compared with a feature vector of a collected human face picture for 10 million times;

2. if a conventional clustering approach is used to divide the 10 million data into 10 thousand clusters, the target human face picture needs to be compared with a vector center point of a cluster for 10 thousand times; each cluster has 1,000 pieces of data on average, and the comparison needs to be done 1,000 times inside each category; the comparison is done 10000+k×1000 times in total; for example, k takes 10, and then the number of times of comparison is 10000+10*1000=20000; wherein when a similar human face picture of the target human face picture is sought in the clusters by an existing near neighbor algorithm, k means that k near neighbor center points are selected, and 10 is its common value;

3. if the technical solution of this embodiment is used, two levels are divided, and there are 100 clusters at the first level, and there are 200 clusters at the second level, then each cluster at the second level has 500 pieces of data on average, and the number of times of comparison is about 100+m×200+n×500;

if m=3, and n=10, the number of times of comparison is 100+3×200+10×500=11100, which may reduce the number of times that the comparison is done significantly as compared to the 1st and the 2nd sections; likewise, m means that m near neighbor center points are selected at the first level, n means that n near neighbor center points are selected at the second level, and 3, 10 are common values.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a human face similarity recognition system according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

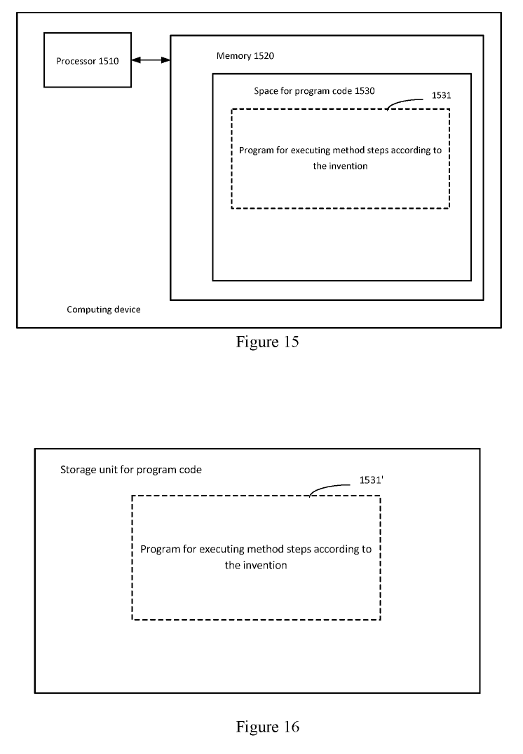

For example, FIG. 15 shows a computing device which may carry out a method according to the invention. The computing device traditionally comprises a processor 1510 and a computer program product or a computer readable medium in the form of a memory 1520. The memory 1520 may be an electronic memory such as a flash memory, an EEPROM (electrically erasable programmable read-only memory), an EPROM, a hard disk or a ROM. The memory 1520 has a memory space 1530 for storing a program code 1531 for carrying out any method step in the methods as described above. For example, the memory space 1530 for a program code may comprise individual program codes 1531 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described in FIG. 16. The storage unit may have a memory segment, a memory space, etc. arranged similarly to the memory 1520 in the computing device of FIG. 15. The program code may for example be compressed in an appropriate form. In general, the storage unit comprises a computer readable code 1531′, i.e., a code which may be read by e.g., a processor such as 1510, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A human face similarity recognition method comprising:
generating a feature vector of a target human face picture according to features of the target human face picture;
generating feature vectors of collected human face pictures according to features of the collected human face pictures; and
selecting from the collected human face pictures at least one human face picture of which the feature vector has the minimum distance to the feature vector of the target human face picture as a similar human face picture of the target human face picture.

2. The method as claimed in claim 1, wherein the step of selecting from the collected human face pictures the at least one human face picture of which the feature vector has the minimum distance to the feature vector of the target human face picture as the similar human face picture of the target human face picture comprises:
aggregating the collected human face pictures into a plurality of categories;
computing a vector center point of human face pictures in each category according to the feature vectors of the human face pictures in said each category; and
taking a human face picture in a category corresponding to a vector center point with the minimum distance to the feature vector of the target human face picture as a similar human face picture of the target human face picture.

3. The method as claimed in claim 1, further comprising:
converting the distance between the feature vector of the similar human face picture and the feature vector of the target human face picture into a similarity score between the similar human face picture and the target human face picture.

4. The method as claimed in claim 3, wherein the step of converting the distance between the feature vector of the similar human face picture and the feature vector of the target human face picture into a similarity score between the similar human face picture and the target human face picture comprises:
when Dx<=Dmin, taking S=Smax, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score; and/or
when Di<Dx<=D(i+1), taking S=Si+K(Dx−Di), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture; and/or
when Dx>Dmax, taking S=Smin, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

5. The method as claimed in claim 1, further comprising:
when there are a plurality of the similar human face pictures, sorting the plurality of the similar human face pictures according to the similarities between the similar human face pictures and the target human face picture.

6. The method as claimed in claim 1, wherein the step of selecting from the collected human face pictures the at least one human face picture of which the feature vector has the minimum distance to the feature vector of the target human face picture as the similar human face picture of the target human face picture comprises:
clustering the collected human face pictures to obtain a plurality of 1st level categories, and through an iterative approach, continuing to cluster human face pictures in at least one i-th level category to obtain a plurality of (i+1)-th level categories, wherein i takes an integer value backward from 1 in order;
recognizing a 1st level category that the target human face picture belongs to, and through an iterative approach, continuing to recognize a (j+1)-th level category that the target human face picture belongs to in a j-th level category that the target human face picture belongs to, wherein j takes an integer value backward from 1 in order; and
continuing to recognize a (j+1)-th level category by the iterative approach, until there is no (j+1)-th level category in the j-th level category that the target human face picture belongs to, and recognizing a similar human face picture of the target human face picture from the j-th level category that the target human face picture belongs to.

7. The method as claimed in claim 6, wherein the step of clustering the collected human face pictures to obtain the plurality of 1st level categories comprises:
setting a plurality of initial center points, dividing the collected human face pictures into the plurality of 1st level categories according to the distances between the feature vectors of the collected human face pictures and each of the initial center points, and computing a vector center point of each 1st level category according to the feature vectors of the human face pictures of said each 1st level category.

8. The method as claimed in claim 6, wherein the step of clustering the collected human face pictures to obtain the plurality of 1st level categories further comprises:
computing a variance between the initial center point and the vector center point of said each 1st level category; and
if the variance exceeds a preset threshold, re-setting the initial center points, re-dividing the collected human face pictures into the plurality of 1st level categories, and re-computing a vector center point of said each 1st level category.

9. The method as claimed in claim 6, wherein the step of recognizing the 1st level category that the target human face picture belongs to comprises:
selecting a 1st level category of which the vector center point has the minimum distance to the feature vector of the target human face picture as the 1st level category that the target human face picture belongs to.

10. The method as claimed in claim 6, wherein the step of recognizing the similar human face picture of the target human face picture comprises:
selecting from the human face pictures of the j-th level category at least one human face picture of which the feature vector has the minimum distance to the feature vector of the target human face picture as the similar human face picture of the target human face picture.

11. A human face similarity recognition system comprising:
a memory having instructions stored thereon;
a processor configured to execute the instructions to perform operations for human face similarity recognition, comprising:
generating a feature vector of a target human face picture according to features of the target human face picture;
generating feature vectors of collected human face pictures according to features of the collected human face pictures; and
selecting from the collected human face pictures at least one human face picture of which the feature vector has the minimum distance to the feature vector of the target human face picture as a similar human face picture of the target human face picture.

12. The system as claimed in claim 11, wherein the operation of selecting from the collected human face pictures the at least one human face picture of which the feature vector has the minimum distance to the feature vector of the target human face picture as the similar human face picture of the target human face picture further comprising:
aggregating the collected human face pictures into a plurality of categories;
computing a vector center point of human face pictures in each category according to the feature vectors of the human face pictures in said each category; and
taking a human face picture in a category corresponding to a vector center point with the minimum distance to the feature vector of the target human face picture as a similar human face picture of the target human face picture.

13. The system as claimed in claim 11, the operations further comprising:
converting the distance between the feature vector of the similar human face picture and the feature vector of the target human face picture into a similarity score between the similar human face picture and the target human face picture.

14. The system as claimed in claim 13, wherein the operation of converting the distance between the feature vector of the similar human face picture and the feature vector of the target human face picture into a similarity score between the similar human face picture and the target human face picture comprises:
when Dx<=Dmin, taking S=Smax, wherein Dx is the distance between the feature vector of the target human face picture and the feature vector of the similar human face picture, Dmin is a preset minimum distance, S is the similarity score between the similar human face picture and the target human face picture, and Smax is a preset maximum similarity score; and/or
when Di<Dx<=D(i+1), taking S=Si+K(Dx−Di), wherein K=(S(i+1)−Si)/(D(i+1)−Di)), Dx is the distance between the feature vector of the target human face picture and the feature vector of the similar human face picture, Di is the distance between the feature vector of a preset first human face picture and the feature vector of the target human face picture, D(i+1) is the distance between the feature vector of a preset second human face picture and the feature vector of the target human face picture, Si is the similarity score between the preset first human face picture and the target human face picture, and S(i+1) is the similarity score between the preset second human face picture and the target human face picture; and/or
when Dx>Dmax, taking S=Smin, wherein Dx is the distance between the feature vector of the target human face picture and the feature vector of the similar human face picture, Dmax is a preset maximum distance, S is the similarity score between the similar human face picture and the target human face picture, and Smin is a preset minimum similarity score.

15. (canceled)

16. The system as claimed in claim 11, wherein the operation of selecting from the collected human face pictures the at least one human face picture of which the feature vector has the minimum distance to the feature vector of the target human face picture as the similar human face picture of the target human face picture comprises:
clustering the collected human face pictures to obtain a plurality of 1st level categories, and through an iterative approach, continuing to cluster human face pictures in at least one i-th level category to obtain a plurality of (i+1)-th level categories, wherein i takes an integer value backward from 1 in order;
recognizing a 1st level category that the target human face picture belongs to, and through an iterative approach, continuing to recognize a (j+1)-th level category that the target human face picture belongs to in a j-th level category that the target human face picture belongs to, wherein j takes an integer value backward from 1 in order; and
when there is no (j+1)-th level category in the j-th level category that the target human face picture belongs to, recognizing a similar human face picture of the target human face picture from the j-th level category that the target human face picture belongs to.

17. The system as claimed in claim 16, wherein the operation of clustering the collected human face pictures to obtain the plurality of 1st level categories comprises:
setting a plurality of initial center points, dividing the collected human face pictures into a plurality of 1st level categories according to the distances between the feature vectors of the collected human face pictures and each of the initial center points, and computing a vector center point of each 1st level category according to the feature vectors of the human face pictures of said each 1st level category.

18. The system as claimed in claim 16, wherein the operation of clustering the collected human face pictures to obtain a plurality of 1st level categories further comprises:
computing the variance between the initial center point and the vector center point of said each 1st level category; and
if the variance exceeds a preset threshold, re-setting the initial center points, re-dividing the collected human face pictures into a plurality of 1st level categories, and re-computing a vector center point of said each 1st level category.

19. The system as claimed in claim 16, wherein the operation of recognizing the 1st level category that the target human face picture belongs to comprises
selecting a 1st level category of which the vector center point has the minimum distance to the feature vector of the target human face picture as the 1st level category that the target human face picture belongs to.

20. The system as claimed in claim 16, wherein the operation of recognizing the similar human face picture of the target human face picture comprises:
selecting from the human face pictures of the j-th level category at least one human face picture of which the feature vector has the minimum distance to the feature vector of the target human face picture as the similar human face picture of the target human face picture.

21. (canceled)

22. A non-transitory computer readable medium storing computer program comprising computer readable codes, and running of said computer readable codes on a computing device causes said computing device to carry out operations for human face similarity recognition, the operations comprising:
generating a feature vector of a target human face picture according to features of the target human face picture;
generating feature vectors of collected human face pictures according to features of the collected human face pictures; and
selecting from the collected human face pictures at least one human face picture of which the feature vector has the minimum distance to the feature vector of the target human face picture as a similar human face picture of the target human face picture.
